(19) United States
(12) Patent Application Publication
(10) Pub. No.: US 2026/0046319 A1
(43) Pub. Date: Feb. 12, 2026

(54) SYSTEMS AND METHODS FOR LOCATION DISCOVERY

(71) Applicant: T-Mobile USA, Inc, Bellevue, WA (US)

(72) Inventor: Hang Hoi Yau, Sammamish, WA (US)

(21) Appl. No.: 18/797,201

(22) Filed: Aug. 7, 2024

(51) Int. Cl. H04L 65/1016; H04L 65/1045; H04L 67/02; H04L 67/55; H04W 64/00

(52) U.S. Cl. CPC H04L 65/1016; H04L 65/1045; H04L 67/02; H04L 67/55; H04W 64/00

(57) ABSTRACT

A location discovery system may use session initiation protocol to provide more efficient means of determining a user's location. An application executing on an IMS application server may request a user's location with an HTTP request. A call session control component may generate an SIP location request message based on the HTTP request and transmit that message to a UE. The UE may solicit approval from the user to provide the device's location to the application. If the user approves, the UE may generate and transmit a responsive SIP user location information message that may be used by the call session control component to generate an HTTP user location message that is then forwarded to the application server.

### BACKGROUND

The capabilities of wireless communications devices (e.g., user devices such as mobile telephones, smartphones, tablets, laptops, etc.) and other types of computing devices have increased exponentially over recent years. The variety and sophistication of services and applications available to such devices over various data networks (e.g., wireless communications networks, the Internet, IP multimedia systems or subsystems (IMSs), and combinations thereof) have likewise grown dramatically. Some such services and applications may use the location of a user device to perform particular operations. However, user devices may be configured to prevent the sharing of location information (e.g., generally and/or in non-emergency communications) in order to maintain user and user device security and safety. Therefore, it may be challenging to enable the use of applications and services on user devices while ensuring user and user device security and safety.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative wireless communications network environment in which systems and methods for location discovery may be implemented, in accordance with examples of the disclosure.

FIG. 2 is a schematic diagram of illustrative functions and communications that may be implemented in a wireless communications network in which systems and methods for location discovery may be implemented, in accordance with examples of the disclosure.

FIG. 3 is a diagram of an illustrative signal flow associated with systems and methods for location discovery, in accordance with examples of the disclosure.

FIG. 4 is a flow diagram of an illustrative process for performing location discovery at a UE, in accordance with examples of the disclosure.

FIG. 5 is a flow diagram of an illustrative process for performing location discovery at an application server, in accordance with examples of the disclosure.

FIG. 6 is a flow diagram of an illustrative process for performing location discovery at an IMS function, in accordance with examples of the disclosure.

FIG. 7 is a schematic diagram of illustrative components in an example user device that is configured for interacting with a wireless communications network to implement location discovery, in accordance with examples of the disclosure.

FIG. 8 is a schematic diagram of illustrative components in an example computing device that is configured for performing one or more aspects of location discovery, in accordance with examples of the disclosure.

### DETAILED DESCRIPTION

### Overview

This disclosure is directed in part to systems and techniques for performing user device location discovery in wireless communications networks and other networks that facilitate communications between computing devices. Such networks include any networks that may facilitate wireless communications services for one or more wireless communications devices. Such networks include networks that support one or more 3GPP standards, including, but not limited to, Long Term Evolution (LTE) networks (e.g., 4G LTE networks), New Radio (NR) networks (e.g., 5G NR networks), and 6G networks. However, the disclosed systems and techniques may be applicable in any network or system in which a user device may request and receive access to communicate with one or more network and/or remote devices using any protocol.

In conventional systems, a wireless user device (e.g., mobile telephone, smartphone, user equipment (UE), etc.; generally referred to as “UE” herein) may wirelessly communicate with a base station (e.g., gNodeB, eNodeB, NodeB, base transceiver station (BTS), etc.) to request wireless communications services, such as a packet data communication session between the user device and a data network (e.g., the Internet, an IP multimedia system or subsystem (IMS), etc.). In examples, such a request for communications may be a request to establish a packet data communications session with a remote device, such as an application server configured at an IMS network. In these and other examples, such a request for communications and related communication may be session initiation protocol (SIP) communications used to establish a voice, video, and/or data communications session between a wireless user device and a remote device, such as an application server.

Various operations may be performed by network components, devices, and/or functions to obtain or otherwise establish the requested services for the wireless user device. Such operations may include authenticating the wireless user device and/or a user of the device, authorizing the requested services for the device and/or user, registering the device at the various systems and functions needed to provide the requested services, etc. In particular, a network operation may include determining or otherwise obtaining an IP address for the user device and providing that address to the user device for use in the requested communications. As used herein, a “request for communications” and a “communications request” may include, but are not limited to, any transmission of data from one device, component, or system that explicitly or implicitly indicates a request for transmission of at least a subset of that data or other data to another device, component, or system. For example, a communications request may be a packet, frame, and/or any other type of data unit transmitted from one device to another device; a request to establish a communications session of any type; a request by one device for data or any other type of response from another device; etc.

For example, a UE may transmit a request for a packet data communications session (e.g., a request to establish a protocol data unit (PDU) session or a packet data network (PDN) connection) with a data network to a base station. A communications session such as a PDU session or PDN connection, for example in an LTE or NR network, may be an end-to-end communications session between a device (e.g., the UE) and a data network and/or a device configured thereon (e.g., the Internet, an IMS, a server configured on the Internet, an application server configured at an IMS, etc.). Such connections or sessions may be referred to generally herein as “communications session” and may include, but are not limited to, any type of PDN connection, PDU session, and any other type of packet data communications connection or session. In examples, the disclosed communications session may be an IP (e.g., IPv4 or IPv6) communications session.

The base station may relay or otherwise convey this communications session request to an access management component (e.g., an access management function (AMF) for NR networks, a mobility management entity (MME) for LTE networks, etc.) in the core of the wireless network in which the base station is configured. The access management component may interact with one or more other components to perform the operations needed to establish this communications session, such as authenticating the device and/or user, registering the UE with the network, etc. In a particular example, the access management component may interact with a session management component (e.g., a session management function (SMF) for NR networks, a serving gateway control plane function (SGW-C) and/or a packet data network gateway control plane function (PGW-C) for LTE networks, etc.) to establish the communications session and/or obtain SMF-related information to be used for communications session establishment on behalf of the UE. As part of this interaction, the access management component may request and receive, or otherwise obtain, an IP address from a session management component for the UE. The access management component may provide this address to the UE that may then use the address for communications with remote devices or systems via the wireless network.

A session management component may perform various session establishment operations, such as determining and assigning particular functions and/or components to service the session, associating policies for the session, etc. In examples, an important function performed by a session management component may be providing the access information needed by the UE to communicate with a data network using the established session, including an address (e.g., IPv4 address or IPv6 address). The session management component provides this information to the access management component for relay to the base station and, ultimately, to the UE requesting the communications session. In examples, the data provided to the access management component and/or the base station may include data indicating one or more user plane components (e.g., a user plane function (UPF) for NR networks, a serving gateway user plane function (SGW-U) and/or a packet data network gateway user plane function (PGW-U) for LTE networks, etc.) with which the UE, via the base station, may communicate to exchange user data with one or more destination devices and/or networks.

For example, the UE may use the provided address to transmit a request to establish a packet data communications session for exchanging user data to an indicated user plane component that may in turn provide that user data to an initial IMS network component, such as a proxy call session control function (P-CSCF) or other call session control component. This initial IMS network component may in turn use the information accompanying the request (e.g., destination address) to route the user data to another component in the IMS network for further routing, etc., until the request reaches its intended destination. For example, a request to exchange user data may be transmitted from a P-CSCF to a serving CSCF (S-CSCF) for forwarding to an application server or other destination system or component. The P-CSCF may determine how to forward communications from a UE (e.g., to an S-CSCF) based on the type of request (e.g., a request to exchange user data). Data responsive to the request may be transmitted from the destination system or component and routed back to the UE using the UE's session management component-assigned address as the destination address using the same or similar components. For instance, SIP may be used to establish a SIP communications session between a UE and an application server at an IMS network. This SIP communications session may then be used to exchange communications between the UE and the application server via the intermediate components as described herein. In examples where a SIP communications session is established between a UE and application server at an IMS network, the SIP communications session may be used to initiate and support one or more IMS data channels that may be used to exchange data (typically data other than voice or video data) between the UE and an application or service executing at the application server.

Some applications and services provided to user devices (e.g., UEs) by remote devices (e.g., application servers) may use a user location. For example, certain operations performed by applications and/or services provided by an application server may be limited users within particular geographical areas (e.g., due to regulations, business rules, security rules, etc.) For instance, banking, financial, insurance, health, and other applications that may deal with personal and/or financial information may be required to operate according to user location-based rules and/or regulations. In other examples, the location of a user or user device may be helpful in performing certain operations, such as troubleshooting technical issues that may be location-related (e.g., determining network-related issues based on user device location). In still other examples, user or user device location may be used to determine the appropriate data to provide to a user (e.g., weather, news, recommendations, mapping data, etc.). Note that a user device location may be used by services and applications as a proxy for a user location.

In current implementations, a user location, when needed, is typically obtained using communications generated and exchanged between applications or services executing above communications session layers (e.g., out of band, for example, the browser executing on a user device to collect location information from a user, which is then provided to an application on an application server, etc.). However, it would be more efficient and effective to perform user device location discovery operations (e.g., directly) via a SIP communications session and/or the IMS data channel. Current technologies allow SIP-based location discovery operations only for emergency communications. For example, when an IMS emergency call is established, the user device may receive a SIP INFO message from an emergency services system at an IMS network requesting the user device location. Because the user device will recognize this request as being associated with the emergency call, the user device may respond with its location (after obtaining its location, if necessary). However, if the user device is not currently engaged in an emergency call or other emergency communications, it may be configured to ignore or otherwise not respond to a SIP INFO request for its location (e.g., received via a SIP communications session supporting IMS data channels rather than an emergency call or other emergency communications).

In order to leverage the efficiency of location discovery via SIP communications sessions, according to the disclosed examples, a user device may be configured with improved functionality for handling a SIP INFO request for a user device location that may be received outside of an emergency communications context. Furthermore, one or more IMS core network components or functions may be configured with improved functionality for detecting requests for a user device location from an application server (e.g., via an IMS data channel), exchanging SIP-based location discovery communications with the user device, and providing received user device location information to the application server.

For example, an application may be executing at an application server and communicating with a UE via one or more IMS data channels supported by a SIP communications session. The application may request a user device location via an IMS data channel facilitated or otherwise supported by a SIP communications session and by an IMS core network function, such as a P-CSCF. In examples, the application may generate this request as a hypertext transfer protocol (HTTP) GET (“HTTP GET”) request for user device location information. The P-CSCF may be configured to, upon detection of this request, generate a SIP INFO communication that requests the UE's location. The P-CSCF may use IMS data channel data and/or SIP communications session data to generate this request and direct it to the UE.

The UE may be configured to request user approval to provide location information upon receiving the SIP INFO location request. For example, the UE may be configured with a dialer component that may facilitate communication with a user of the UE. The dialer may be configured with a location determination component or function that may generate an interface requesting approval to provide the UE's location to the application. This interface may be presented to the user (e.g., on a display of the device, audibly, tactilely, etc.). The user may provide input approving or denying the request (e.g., via touchscreen, audibly, tactilely via a button, etc.). If the user provides input approving the provision of location information to the application, the UE may generate and transmit a responsive SIP PUBLISH communication that provides the UE's location to the P-CSCF that originated the SIP INFO location request. If necessary, the UE may first perform one or more operations to determine its current location. In other examples, the UE may retrieve its current location from memory or data storage.

The P-CSCF may be configured to receive the SIP PUBLISH communication with the UE's location data and responsively generate an “HTTP PUT” communication based on that location data. The HTTP PUT communication may be generated to be responsive to the HTTP GET request for user device location information initially received from the application. The P-CSCF may transmit this HTTP PUT UE location communication to the application (e.g., via an IMS data channel). The application may then use the UE location information to perform one or more location-dependent operations.

By facilitating the use of SIP communications session features and IMS data channel features, the systems and methods described herein provide more efficient location discovery operations and reduced resource utilization, while maintaining the security and safety of user device location data. By ensuring that a user is actively involved in approving the use of user device location data while using the more efficient communications session means of requesting and providing such data, the systems and methods described herein provide an improved user experience and increase resource utilization efficiency. For example, the methods and systems described herein may be more efficient and/or more robust than conventional techniques, as they may increase the speed and efficiency of determining user device location data while reducing the wasting of resources on higher layer operations for such location discovery operations. That is, the methods and systems described herein provide a technological improvement over existing non-emergency location discovery systems and processes by facilitating increased network efficiency by reducing the traffic associated with location discovery (e.g., when performed out-of-band rather than in-band as described herein). This allows the systems and methods described herein to provide more robust systems by, for example, making more efficient use of network devices by reducing unnecessary and/or unproductive device and network signaling and processing associated with out-of-band location discovery, thereby freeing network and device resources for more productive operations. Moreover, the systems and methods described herein can ensure that a user approves the use of the user device location, thereby maintaining and improving the security and safety of application interaction for the user.

Illustrative environments, signal flows, and techniques for implementing systems and methods for emergency communications management are described below. However, the described systems and techniques may be implemented in other environments.

### Illustrative System Architecture

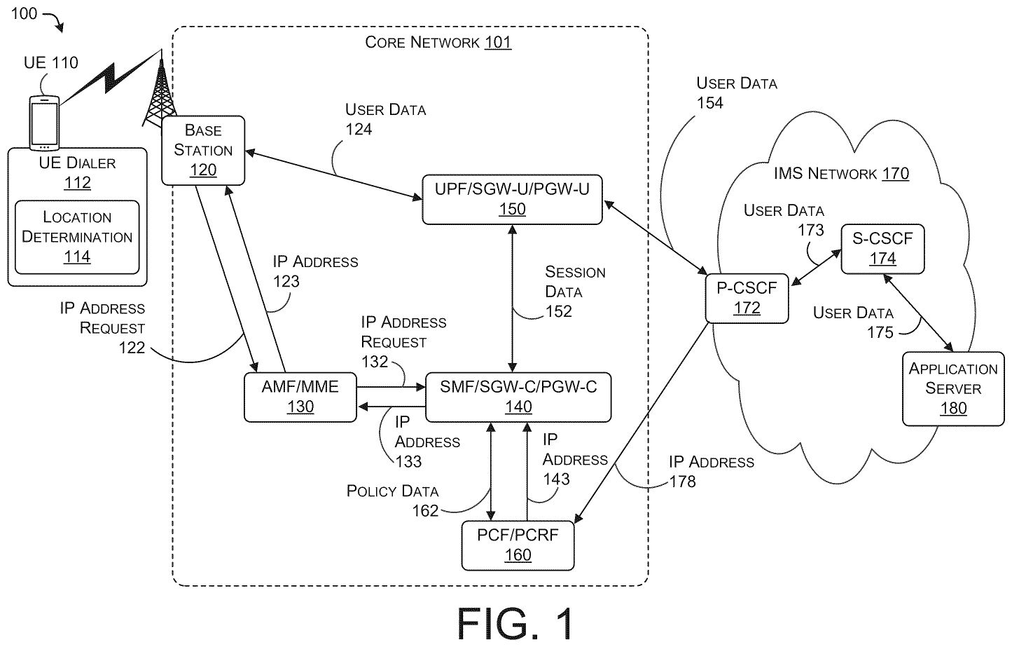

FIG. 1 is a schematic diagram of an illustrative wireless network environment 100 in which the disclosed systems and techniques may be implemented. The environment 100 may include a UE 110 that may wirelessly communicate with a base station 120. The base station 120 may be any type of base station, including, but not limited to, any type of BTS, NodeB, eNodeB, gNodeB, etc. The base station 120 may communicate with other components and functions in a core network 101. The core network 101 may be any one or more networks that facilitate communications between particular devices, components, and/or functions of various types in the core of a wireless communications network that may facilitate communication between computing devices and/or mobile devices (e.g., UEs). Various connections between components and functions in the core network 101 may be wired, wireless, or a combination thereof. The components and functions described herein may be implemented as physical devices, as software components and/or functions executing on one or more computing devices, and as any combination thereof. In various embodiments, the core network 101 may facilitate the establishment of communications sessions for one or more wireless devices, such as UE 110. In examples, the core network 101 may facilitate packet-based communications between such wireless devices and other wireless devices, devices on the Internet, one or more IMSs and/or devices configured thereon, and/or one or more other data networks (DNs). For example, the core network 101 may facilitate packet-based (e.g., IP) communications between the UE 110 and an IMS network 170 that may be any one or more IMS networks.

In FIG. 1, connections between components may be logical and/or communications connections that may be facilitated by one or more wired and/or wireless connections and may include traversal of one or more devices, components, and/or functions that may or may not be shown in FIG. 1.

In environment 100, the UE 110 may communicate with the base station 120 to request the establishment of a communications session (e.g., to communicate with one or more systems at the IMS network 170, such as an application server 180). For example, the UE 110 may, as part of or inherent in requesting the establishment of a communication session, request an IP address for use in communicating with the IMS network 170. The base station 120 may relay the IP address request or otherwise transmit an IP address request 122 an AMF/MME 130, which may be any type of access management component as described herein. The IP address request 122 may be a network access request that provides information that the AMF/MME 130 may use to determine and/or obtain an IP address for the UE 110, such as an indication of the base station 120's tracking area code (TAC) and/or an indication of the UE 110's PDN-Type, which may have been provided by the UE 110 in the request to establish the communications session. For example, the UE 110's PDN-Type may indicate that the UE is requesting an IPv4 address, an IPV6 address, or one of either an IPv4 address or an IPV6 address.

In various examples, the AMF/MME 130 may perform one or more operations to establish a communications session for the UE 110. For example, the AMF/MME 130 may perform or initiate operations to authenticate and authorize the UE 110 and/or a user associated with the UE 110, create contexts for a session, determine and apply session policies, establish user plane resources, etc. In examples, the AMF/MME 130 may determine a session management component, such as SMF/SGW-C/PGW-C 140, for performing session management operations based on the UE 110, the base station 120, and/or the request PDN-Type. The AMF/MME 130 may transmit and/or forward an IP address request 132 based on the IP address request 122 to the SMF/SGW-C/PGW-C 140 requesting an IP address (e.g., among other session data) for the UE 110.

The SMF/SGW-C/PGW-C 140 may respond to the request 132 with a responsive message transmitted to the AMF/MME 130 that may include an IP address 133. This responsive message may further include other information, such as user plane data for use by the UE 110 (e.g., an indication of a user plane component, such as UPF/SGW-U/PGW-U 150). The SMF/SGW-C/PGW-C 140 may determine or obtain the IP address 133 from a set of authorized IP addresses, for example, configured at the SMF/SGW-C/PGW-C 140. The SMF/SGW-C/PGW-C 140 may also, or instead, obtain an IP address 143 from the PCF/PCRF 160, which may obtain an IP address 178 from the P-CSCF 172. The SMF/SGW-C/PGW-C 140 may further determine policy data for the requested communications session and/or perform other operations to establish session data via interactions with one or more other components of the core network 101. For example, the SMF/SGW-C/PGW-C 140 may exchange policy data 162 with a policy component, such as PCF/PCRF 160 to determine session data for the requested communications session for the UE 110. The SMF/SGW-C/PGW-C 140 may further exchange session data 152 with the UPF/SGW-U/PGW-U 150 to establish session resources for the UE 110's user data at the UPF/SGW-U/PGW-U 150. As used herein, “user data” includes any data used to establish and maintain communications sessions, such as SIP communications sessions and IMS data channels, that may support the exchange of data between an application and a user device, as well as the application data exchanged between an application and a user device using such communications sessions.

The AMF/MME 130 may provide the IP address 123 (e.g., based on, or the same as, the IP address 133) to the base station 120 for configuration at the UE 110 for use in the requested communications session. The AMF/MME 130 may further provide other data for use by the base station 120 and/or UE 110 for the communications session, such as an address or indication for the UPF/SGW-U/PGW-U 150.

Having received an IP address and session information, the UE 110 may now attempt to establish a packet communications session with a remote system or component. For example, the UE 110 may transmit a request to establish a SIP communications session with the application server 180 via user data 124 that is transmitted to the UPF/SGW-U/PGW-U 150. The UPF/SGW-U/PGW-U 150 may relay this request (or generate a similar request based on the received SIP INVITE request) via user data 154 to a P-CSCF 172 configured at the IMS network 170 at which the application server 180 may be configured. The P-CSCF 172 may relay this request (or generate a similar request based on the received SIP INVITE request) via user data 173 to the S-CSCF 174 configured at the IMS network 170 to serve the application server 180. The S-CSCF 174 may then provide the request to the application server 180. The application server 180 may responsively generate and transmit one or more SIP communications to establish a SIP communications session with the UE 110 (e.g., via the user data 175, the S-CSCF 174, the user data 173, the P-CSCF 172, the user data 154, the UPF/SGW-U/PGW-U 150, the user data 124, and the base station 120). As will be appreciated, there may be several other components and functions not described herein that may be configured at the core network 101 and the IMS network 170 and potentially involved in the processes described herein.

Supported by this established SIP communications session, the UE 110 and the application server 180 may establish one or more IMS data channels that may be used to exchange data between these devices (e.g., via the user date 175, the S-CSCF 174, the user data 173, the P-CSCF 172, the user data 154, the UPF/SGW-U/PGW-U 150, the user data 124, and the base station 120). In examples, the UE 110 may interact with an application or server executing on the application server 180 using these one or more IMS data channels.

The application or server executing on the application server 180 may request a location from the UE, for instance, as needed to perform one or more operations. In examples, the application server 180 may generate this request as an HTTP GET user location request and transmit this request (e.g., via an IMS data channel) to the P-CSCF 172 via user data 175, S-CSCF 174, and user data 173. The P-CSCF 172 may detect the HTTP GET user location request within an IMS data channel between the UE 110 and the application server 180. In response to detecting the HTTP GET user location request, the P-CSCF 172 may generate a SIP INFO location discovery message (in examples, also based on information associated with the IMS data channel, such as UE address, application server address, etc.) requesting location information for the UE 110. In some examples, the P-CSCF 172 may be configured to recognize that the HTTP GET user location request is being transmitted in a non-emergency context and further use this as a basis for generating the SIP INFO communication. The P-CSCF 172 may transmit the SIP INFO location discovery message to the UE 110 via user data 154, the UPF/SGW-U/PGW-U 150, the user data 124, and the base station 120. The base station 120 may further transmit this message to the UE 110.

The UE 110 may receive the SIP INFO location discovery message for processing at the UE dialer 112. The UE dialer 112 may be a component configured at the UE 110 to perform dialing functions and facilitate interactions with the user of the UE 110. In examples, the UE dialer 112 may also, or instead, be a SIP-based communication application, such as a voice calling app, a messaging app, a chat app, and the like. In further examples, the UE dialer 112 may be any application that includes a location determination component, such as the location determination component 114 described herein, and/or the capability perform operations associated with the location determination component as described herein.

In examples, the UE dialer 112 may include a location determination component 114 that may represent any code, component, or functionality configured to perform the location discovery approval operations on a UE as described herein. For example, in response to detecting a SIP INFO location discovery message, the UE dialer 112 may be configured to present an interface to the user (e.g., on a display of the UE 110, audibly via a speaker configured the UE 110, etc.) requesting approval to provide the UE's location to the application server 180. This interface may provide information about the application requesting the location information and user-activatable input for approving or denying the request to provide the UE's location.

If the user denies providing the location, the UE dialer 112 and/or the location determination component 114 may simply not respond to the SIP INFO location discovery message or may generate and transmit a denial of the request. On the other hand, if the user approves, the UE dialer 112 and/or the location determination component 114 may generate and transmit a SIP PUBLISH location information message back to the P-CSCF 172 (e.g., via the base station 120, the user data 124, the UPF/SGW-U/PGW-U 150, and the user data 154). In generating this SIP PUBLISH location information message, the location determination component 114 and/or the dialer 112 may determine the UE's current location by retrieving location data from local memory or data storage and/or by performing one or more location determination operations (e.g., query the network). In examples, the location determination component 114 and/or the dialer 112 may further confirm that the UE 110 is not currently engaged in emergency communication or otherwise determine that the SIP INFO location discovery message is not associated with emergency communications as part of the operations of requesting approval for providing the location and/or generating the SIP PUBLISH location information message.

The SIP PUBLISH location information message may be received at the P-CSCF 172, which may determine that this message is in response to the SIP INFO location discovery message it transmitted earlier and the HTTP GET user location request received from the application server 180. In response, the P-CSCF 172 may generate an HTTP PUT user location message that contains or otherwise represents the UE location information included in the received SIP PUBLISH location information message. The P-CSCF 172 may then transmit this SIP PUBLISH location information message to the application server 180 via the user data 173, the S-CSCF 174, and the user data 175. The application server 180 may then use the location information contained in this message to perform one or more location-dependent operations. These and other operations are described in more detail below.

### Illustrative Functions and Communications

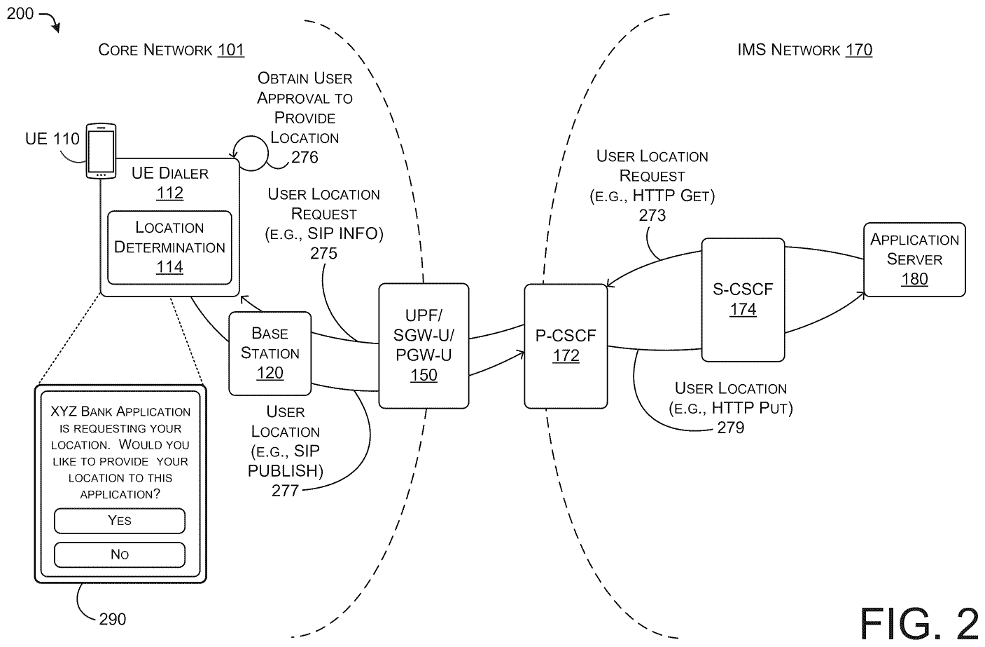

FIG. 2 illustrates a schematic diagram of exemplary functions and communications of various messages that may be exchanged in one or more of the disclosed systems and techniques for location discovery as described herein. Reference may be made in this description of the exemplary functions and communications to devices, messages, functions, components, and/or operations illustrated in other figures and described in regard to those figures. However, the functions and communications illustrated in FIG. 2 and described herein may be implemented in any suitable system and/or with any one or more suitable devices and/or entities. Moreover, any of the functions and communications described in regard to FIG. 2 may be used separately and/or in conjunction with other functions and communications and/or implemented using devices, systems, and or operations. All such embodiments are contemplated as within the scope of the instant disclosure.

FIG. 2 illustrates schematic diagram 200 that may represent a subset of the functions and components represented in environment 100 of FIG. 1. Various components and functions of FIG. 1 have been omitted from this figure for clarity. As one skilled in the art will appreciate, there may be various additional and/or alternative components and functions that may be configured in a system such as that illustrated in schematic diagram 200. All such embodiments are contemplated as within the scope of the instant disclosure.

In this example, a SIP communications session have been established between the UE 110 and the application server 180. Communications between the UE 110 and the application sever 180 may be facilitated by this session as well as one or more IMS data channels established between the UE 110 and the application server 180.

In an example, the application server 180 may generate a user location request 273 that may, in some instances, be an HTTP GET user location request. The application server 180 may transmit the user location request 273 to the P-CSCF 172 via the S-CSCF 174.

The P-CSCF 172 may receive the user location request 273 and responsively determine to generate a user location request 275 that may be a SIP INFO location discovery message. The P-CSCF 172 may transmit the user location request 275 to the UE 110 via the UPF/SGW-U/PGW-U 150 and the base station 120.

The UE 110 may receive this user location request 275 at the UE dialer 112 and may process the user location request 275 using the location determination component 114. The location determination component 114 may perform one or more operations 276 to obtain user approval to provide the location of the UE 110 to the application server 180. In examples, the location determination component 114 may interact with the UE dialer 112 to generate and present an interface 290 to the user on a display or other output device of the UE 110. The interface 290 may include information about the request for location information as well as one or more inputs configured to accept user input approving or denying the request for the location information.

In response to receiving input via the interface 290 that the user approves providing location information to the application server 180, the location determination component may determine the UE's location and generate a responsive user location message 277 that may, in examples, be a SIP PUBLISH location information message. The UE 110 may transmit the user location message 277 to the P-CSCF 172 via the UPF/SGW-U/PGW-U 150.

The P-CSCF 172 may receive the user location message 277 and responsively determine an IMS data channel and/or destination application server. Using this information, the P-CSCF 172 may generate a user location message 279 that may, in examples, be an HTTP PUT user location message that contains or otherwise represents the UE location information included in the received user location message 277. The P-CSCF 172 may then transmit this user location message 279 to the application server 180 via the S-CSCF 174. The application server 180 may use the location information contained in the user location message 179 to perform one or more location-dependent operations.

### Illustrative Signal Flow

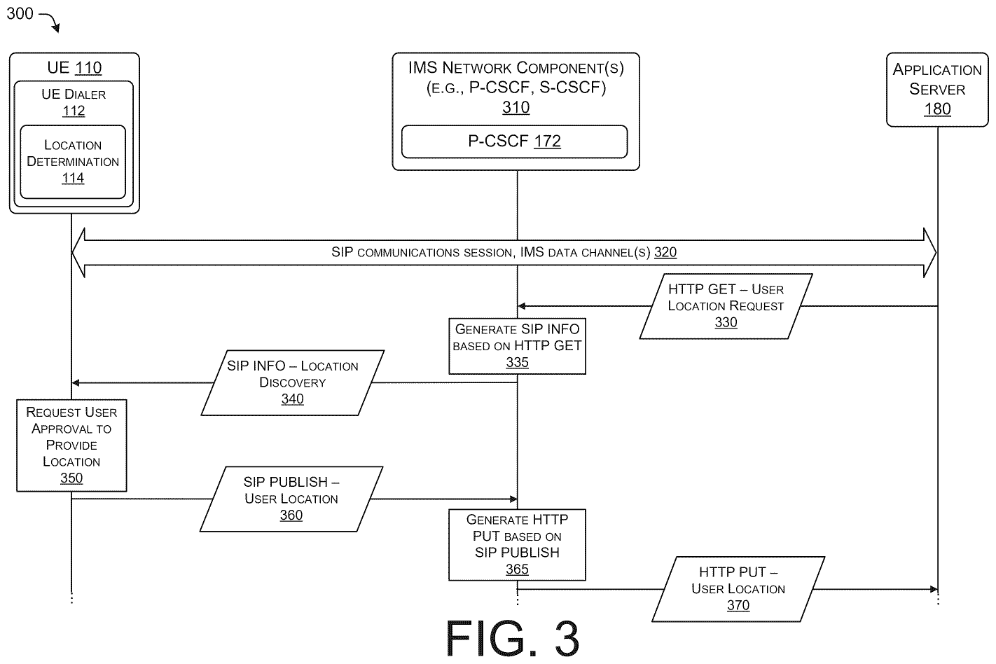

FIG. 3 illustrates an exemplary signal flow 300 of various messages that may be exchanged in one or more of the disclosed systems and techniques for location discovery. Reference may be made in this description of the signal flow 300 to devices, entities, and data illustrated in other figures and described in regard to those figures. However, the operations, signals, and signal flow illustrated in FIG. 3 and described herein may be implemented in any suitable system and/or with any one or more suitable devices and/or entities. Moreover, any of the operations, signals, and/or entities described in regard to FIG. 3 may be used separately and/or in conjunction with other operations, signals, and/or entities. All such embodiments are contemplated as within the scope of the instant disclosure.

Initially, one or more communications sessions 320 may be established between the UE 110 and the application server 180. These communication session(s) may be established via various IMS network components 310 as described herein (e.g., P-CSCF, S-CSCF, etc.), as well as various core network components (e.g., components of the core network 101 of FIG. 1). Included in and/or facilitating the communications session(s) 320 may be a SIP communications session and/or one or more IMS data channels established and supported by the SIP communications session. For example, a SIP communications session may be used to facilitate the establishment of one or more IMS data channels for use in exchanging data between the UE 110 and an application executing on the application server 180.

An application executing at the application server 180 and communicating with the UE 110 via the communication session(s) and/or channels 320 may determine that a location of a user or user device may be required to perform one or more operations. Based on this determination, the application server 180 (e.g., the application executing at the application server 180) may generate a request for user location information. In examples, this request may be an HTTP GET user location request 330. The HTTP GET user location request 330 may be transmitted (e.g., via various IMS network components) to one or more of the IMS network components 310, such as the P-CSCF 172. The HTTP GET user location request 330 may be transmitted in an IMS data channel of the communication session(s) and/or channels 320.

On receiving the HTTP GET user location request 330 in an IMS data channel, the P-CSCF 172 may determine that the message is a request for UE location information, and further determine that the destination UE for the request is UE 110 (e.g., based on the IMS data channel in which the HTTP GET user location request 330 was detected). At operation 335, the P-CSCF 172 may responsively generate a SIP INFO location discovery message 340 based on the HTTP GET user location request 330 and the determined destination UE. The P-CSCF 172 may transmit the SIP INFO location discovery message 340 to the UE 110 (e.g., via various core network components).

The SIP INFO location discovery message 340 may be received at the UE 110 and processed by the UE dialer 112. In examples, the location determination component 114 of the UE dialer 112 may be used to process such location requests. At operation 350, the location determination component 114 and/or the UE dialer 112 may determine that user approval is to be solicited based on the SIP INFO location discovery message 340. The location determination component 114 and/or the UE dialer 112 may generate an interface that may be presented to the user on a display or other output device of the UE 110. This interface may request input from the user approving or denying transmission of the UE location to the requesting application. This interface may further include information identifying the application, the application's use of the location information (e.g., as provided by the application), and/or other information that may assist the user in determining whether to approve providing the location.

If the location determination component 114 and/or the UE dialer 112 does not receive user approval to provide the location to the application, or fails to receive a user response, the location determination component 114 and/or the UE dialer 112 may take no further action. Alternatively, the location determination component 114 and/or the UE dialer 112 may generate a denial message or some other indication that the UE location will not be provided that may be transmitted to the application server 180.

If, at operation 350, the location determination component 114 and/or the UE dialer 112 receives user approval to provide the location to the application, the location determination component 114 and/or the UE dialer 112 may generate a SIP PUBLISH user location message 360 that may include data representing the (e.g., current) location of the UE 110. The location determination component 114 and/or the UE dialer 112 may determine the UE's location using any suitable means, including as noted herein. The UE 110 may transmit the SIP PUBLISH user location message 360 to the P-CSCF 172 (e.g., via various core network components). In examples, the SIP PUBLISH user location message 360 may be addressed or otherwise destined for the application server 180 and may be intercepted on transit by the P-CSCF 172, for example, within an IMS data channel configured for exchanging communications between the application server 180 and the UE 110.

At operation 365, on receiving the SIP PUBLISH user location message 360 (e.g., in an IMS data channel), the P-CSCF 172 may generate an HTTP PUT user location message 370 based on the location information represented in the SIP PUBLISH user location message 360. In examples, the P-CSCF 172 may determine that the message 360 is a user location information message and may further determine that the destination for the message 360 is the application server 180 (e.g., based on the IMS data channel in which the SIP PUBLISH user location message 360 was detected). The P-CSCF 172 may use this information to generate the HTTP PUT user location message 370. The P-CSCF 172 may then transmit the HTTP PUT user location message 370 to the application server 180. The application server 180 may provide the location information represented in the HTTP PUT user location message 370 to the application that requested such information for use in one or more location-dependent operations.

### Illustrative Operations

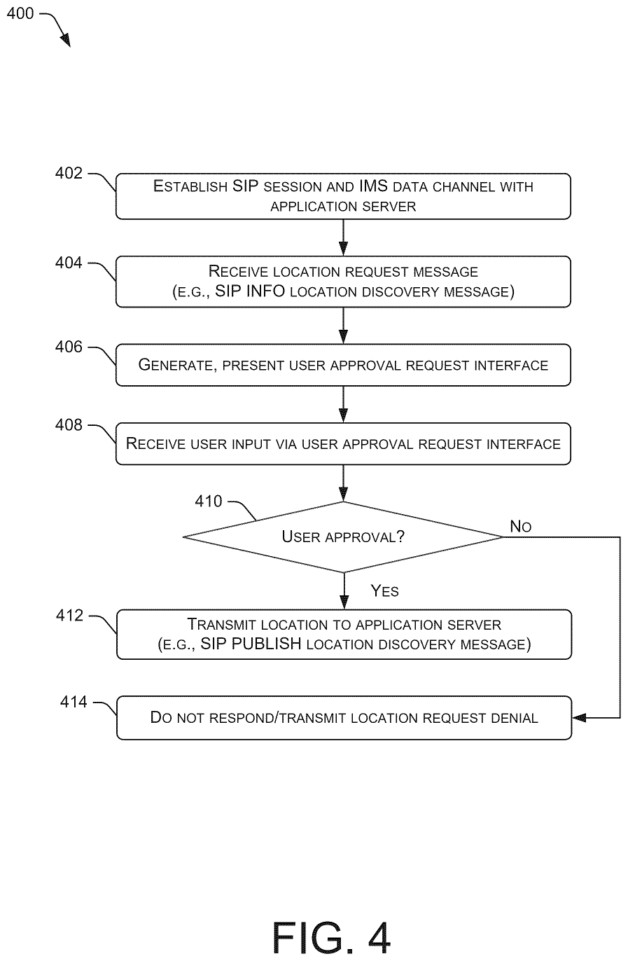

FIG. 4 shows a flow diagram of an illustrative process 400 for location discovery at a UE according to the disclosed embodiments. The process 400 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 400 may be described with reference to the wireless network environment 100 of FIG. 1 and/or other components, functions, communications, and operations described herein; however, other environments, components, functions, communications, and operations may also be used.

At operation 402, a UE may facilitate the establishment of a SIP communications session and one or more IMS data channels for use in communicating with a remote application executing at an application server configured at an IMS network. This operation may be initiated based on the (e.g., user-requested) execution of an application on the UE. This application may be configured to interact with the remote application at the application server.

At operation 404, the UE may receive a request for user location information from, or on behalf of, the remote application. This request may be in the form of a SIP INFO location discovery message and/or may be received via an IMS data channel from a P-CSCF in communications with the remote application. As described in more detail herein, the P-CSCF may generate this SIP INFO location discovery message based on an HTTP GET message received from the application server.

In examples, at operation 404, the received request for user location information may be provided to the UE dialer and/or a location determination component of the UE dialer. In response to receiving the request, the UE dialer and/or the location determination component may determine that the request is not associated with emergency communication and, therefore, that user approval must be received to provide this location information to the remote application.

At operation 406, based on determining that user approval is to be obtained before providing location information, the UE dialer and/or the location determination component may generate and present, to the user, a user approval interface requesting user input for approving or denying the provision of the location information to the remote application. In examples, the interface may be a graphical user interface with inputs that may be used by the user to provide approval or denial for providing user location to the remote application. Other interface types and/or means of requesting and receiving instructions from a user may also, or instead, be used in the disclosed systems and methods.

At operation 408, the UE dialer and/or the location determination component may receive input from the user via the interface presented at operation 406. Note that, in some examples, the UE dialer and/or the location determination component may not receive any response or other input via this interface (e.g., for at least a threshold period of time following the presentation of the interface). In such cases, the UE dialer and/or the location determination component may take no further action or may transmit a location request denial message at operation 414.

If input is received from the user via the interface at operation 408, at operation 410, the UE dialer and/or the location determination component may evaluate this input. If the input indicates that the user denies approval of providing the location information to the remote application, at operation 414, the UE dialer and/or the location determination component may take no further action. Alternatively, at operation 414, the UE dialer and/or the location determination component may transmit request denial message to the remote application indicating that the request for location information (e.g., represented by a SIP INFO location discovery message) received at operation 404 is denied.

If, at operation 410, the UE dialer and/or the location determination component determines that the input received at operation 408 indicates that the user approves of providing the location information to the remote application, at operation 412 the UE dialer and/or the location determination component may determine a current location for the UE and generate a user location information message to the P-CSCF and/or the remote application. In examples, the UE dialer and/or the location determination component may generate a SIP PUBLISH location discovery message that includes data representing the UE location. The UE may transmit this message to the P-CSCF for conveyance of the location information to the remote application.

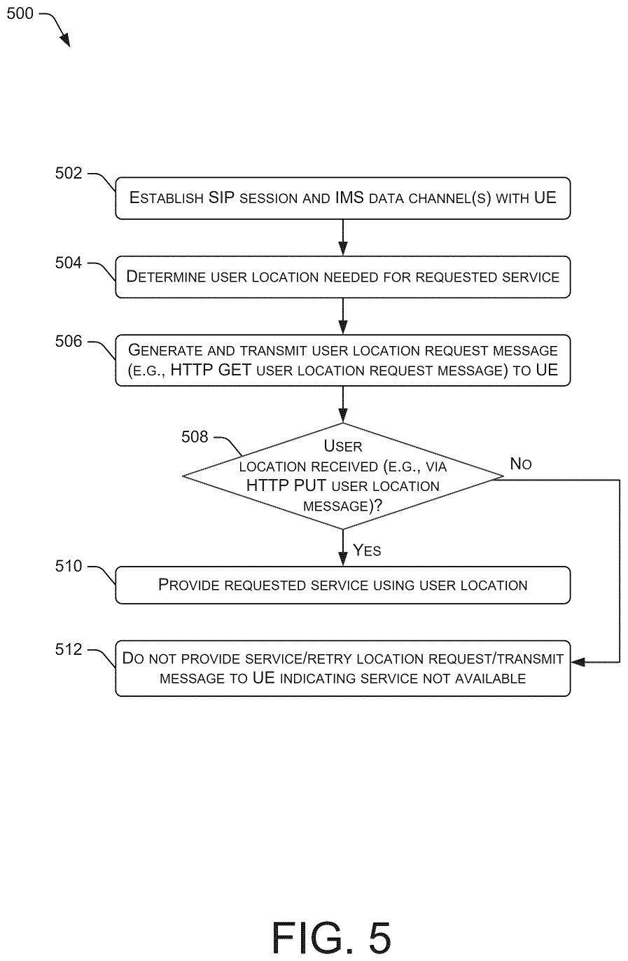

FIG. 5 shows a flow diagram of an illustrative process 500 for location discovery at an application server according to the disclosed embodiments. The process 500 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 500 may be described with reference to the wireless network environment 100 of FIG. 1 and/or other components, functions, communications, and operations described herein; however, other environments, components, functions, communications, and operations may also be used.

At operation 502, an application server configured at an IMS network may facilitate the establishment of a SIP communications session and one or more IMS data channels for use in communicating with a UE. This operation may be initiated based on the (e.g., user-requested) execution of an application on the UE that initiated the establishment of the communications session(s) for use in exchanging communications with the application server. This application executing at the application server may be configured to interact with the UE (e.g., an application executing at the UE).

At operation 504, the application executing at the application server may determine that user location information for the UE may be required or useful in performing one or more operations of the application. For example, the application may determine that a user location (for which a UE location may serve as a proxy) may be needed to determine applicable data and/or interactions with the UE.

Based on determining a need for user location information (and, in examples, further based on determining that the applicant does not have current user location information), at operation 506, the application may generate a user location request message for transmission to the UE. This request may be in the form of an HTTP GET user location request message. Further at operation 506, the application server may transit this message via an IMS data channel to a P-CSCF in communications with the core network with which the UE may be in communication. As described in more detail herein, the P-CSCF may receive this HTTP GET user location request message from the application server and generate a SIP INFO location discovery message for transmission to the UE requesting the UE location information.

At operation 508, the application may determine whether a response has been received from the UE and/or the P-CSCF indicating a user location. In examples, the application may set a timer and determine, at the expiration of the timer (e.g., after a threshold time period) whether a response has been received. If no response has been received, at operation 512, the application may not perform the location-dependent operations that initiated the request for user location information. Further at operation 512, in some examples, the application may transmit one or more communications to the UE indicating that such operations were not able to be performed.

If, as determined at operation 508, user location information is received, at operation 510, the application may perform the location-dependent operations, such as providing location-dependent services. In examples, the user location information may be received as an HTTP PUT user location message transmitted by a P-CSCF that may have generated such a message based on a SIP PUBLISH location information received from the UE.

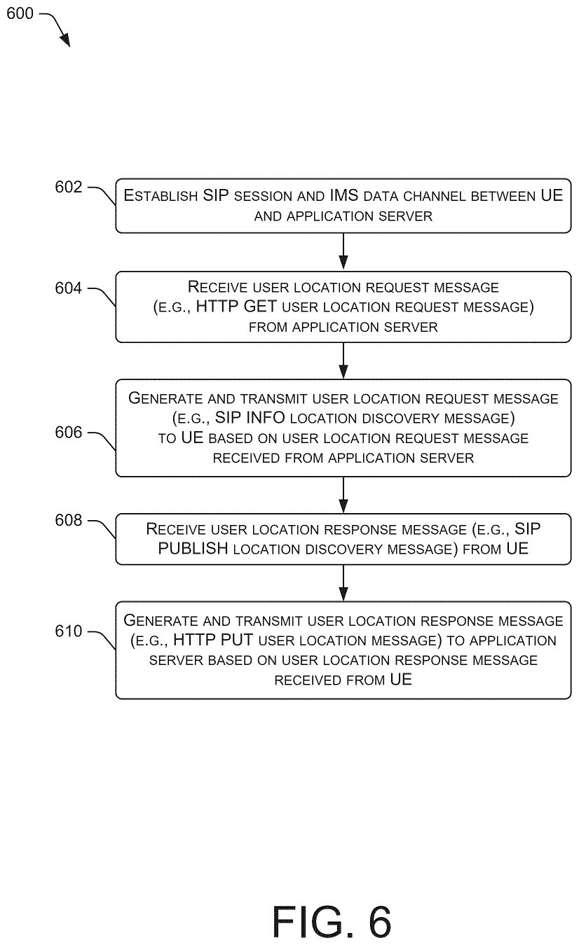

FIG. 6 shows a flow diagram of an illustrative process 600 for location discovery at an IMS network function, such as a CSCF (e.g., a P-CSCF, an S-CSCF, etc.), according to the disclosed embodiments. The process 600 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 600 may be described with reference to the wireless network environment 100 of FIG. 1 and/or other components, functions, communications, and operations described herein; however, other environments, components, functions, communications, and operations may also be used.

At operation 602, a CSCF configured at an IMS network may facilitate the establishment of a SIP communications session and one or more IMS data channels for use in exchanging communications between an application server and a UE. This operation may be initiated based on the (e.g., user-requested) execution of an application on the UE that initiates the establishment of the communications session(s) for use in exchanging communications with the application server. This application executing at the application server may be configured to interact with the application executing at the UE.

At operation 604, the CSCF may detect a user location request message that may have been transmitted by the application server with the UE as an intended destination. The CSCF may detect this message in an IMS data channel associated with the UE and the application server. In examples, this message may be an HTTP GET user location request message.

At operation 606, based on detecting the user location request message from the application server, the CSCF may generate a location discovery message for transmission to the UE. For example, based on the HTTP GET user location request message, the CSCF may generate a SIP INFO location discovery message, in examples, also based on information associated with the IMS data channel in which the HTTP GET user location request message was detected. Information that may be derived from the IMS data channel may include the UE address, the application server address, etc. In some examples, the CSCF may further determine that the HTTP GET user location request or other user location request message is being transmitted in a non-emergency context and further use this as a basis for generating the location discovery message or SIP INFO communication for transmission to the UE. Further at operation 606, the CSCF may transmit the location discovery message or SIP INFO location discovery message to the UE via an IMS data channel established for the UE and application server communications.

At operation 608, the CSCF may receive a user location response message from the UE. In examples, this message may be a SIP PUBLISH location information message. This message may be detected in an IMS data channel established for the UE and application server communications.

At operation 610, based on detecting the user location response message from the UE, the CSCF may generate a user location response message for transmission to the application server. The CSCF may include in this message data representing the location of the UE as represented in the received user location response message. For example, based on the SIP PUBLISH location information message, the CSCF may generate an HTTP PUT user location message that includes the location indicated in the SIP PUBLISH location information message. In examples, this HTTP PUT user location message may also be based on information associated with the IMS data channel in which the SIP PUBLISH location information message was detected. As noted, information that may be derived from the IMS data channel may include the UE address, the application server address, etc. Further at operation 610, the CSCF may transmit the user location response message or SIP PUBLISH location information message to the application server via the IMS data channel established for the UE and application server communications.

Note that any of the operations performed in the processes 400, 500, and 600 may be combined, along with any other operations of functions described herein, and may be performed in any order. Any other combinations and subsets of operations are contemplated as within the scope of the instant disclosure.

In summary, by more efficiently performing UE location discovery in-band for applications executing on application servers configured at an IMS network, the disclosed systems and techniques increase the efficiency of usage of core network and IMS network resources and other wireless network resources and improve the performance of both the networks and user devices, while facilitating location-based operations of various applications and services.

### Example User Equipment

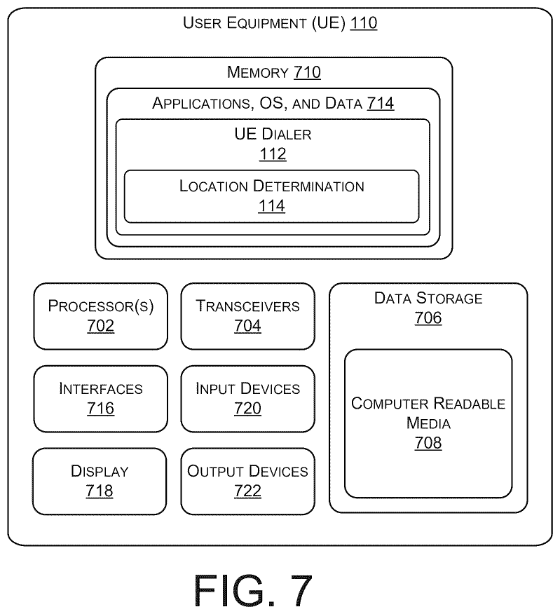

FIG. 7 is an example of a UE, such as UE 110, for use with the systems and methods disclosed herein, in accordance with some examples of the present disclosure. The UE 110 may include one or more processors 702, one or more transmit/receive antennas (e.g., transceivers or transceiver antennas) 704, and a data storage 706. The data storage 706 may include a computer-readable media 708 in the form of memory and/or cache. This computer-readable media may include a non-transitory computer-readable media. The processor(s) 702 may be configured to execute instructions, which can be stored in the computer-readable media 708 and/or in other computer-readable media accessible to the processor(s) 702. In some configurations, the processor(s) 702 is a Central Processing Unit (CPU), a Graphics Processing Unit (GPU), or both CPU and GPU, or any other sort of processing unit. The transceiver antenna(s) 704 can exchange signals with a base station, such as base station 120.

The UE 110 may be configured with a memory 710. The memory 710 may be implemented within, or separate from, the data storage 706 and/or the computer-readable media 708. The memory 710 may include any available physical media accessible by a computing device to implement the instructions stored thereon. For example, the memory 710 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the UE 110.

The memory 710 can store several modules, such as instructions, data stores, and so forth that are configured to execute on the processor(s) 702. In configurations, the memory 710 may also store one or more applications 714 configured to receive and/or provide voice, data, and messages (e.g., SMS messages, Multi-Media Message Service (MMS) messages, Instant Messaging (IM) messages, Enhanced Message Service (EMS) messages, etc.) to and/or from another device or component (e.g., the base station 120). The applications 714 may also include one or more operating systems and/or one or more third-party applications that provide additional functionality to the UE 110. The applications 714 may also include one or more dialers and related components, such as the UE dialer 112 and the location determination component 114. The memory may also, or instead, store bandwidth information, such as UE-supported bands, bandwidth(s), and bandwidth parts, one or more IP addresses, indications of sets of IP addresses, as well as communications session information such as UE-specific carrier bandwidth(s). The memory may also, or instead, store permit list and/or block list information, PDN-Type information, session management component information, user plane component information, policy component information, etc.

Although not all illustrated in FIG. 7, the UE 110 may also comprise various other components, e.g., a battery, a charging unit, one or more network interfaces 716, an audio interface, a display 718, a keypad or keyboard, and one or more input devices 720, and one or more output devices 722.

### Example Computing Device

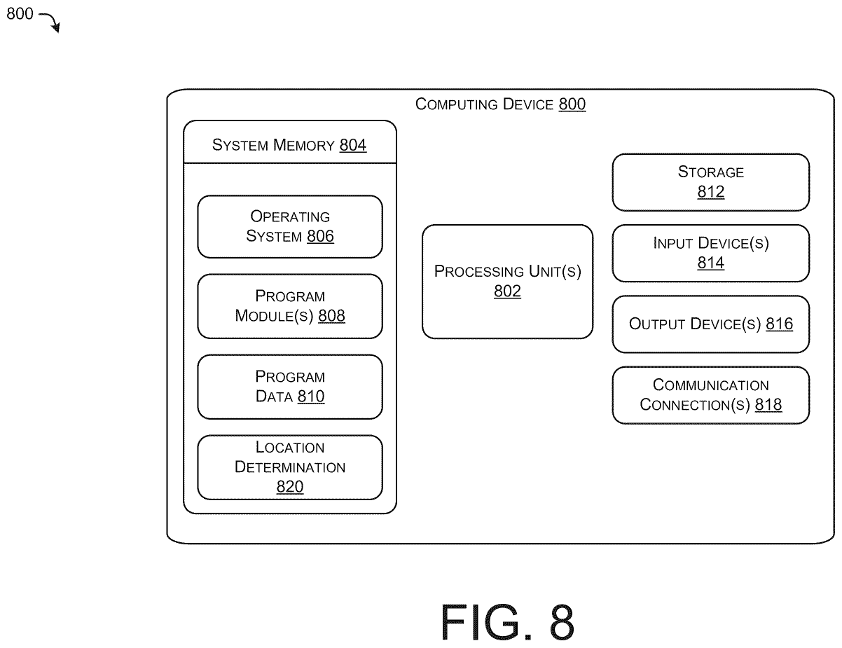

FIG. 8 is an example of a computing device 800 for use with the systems and methods disclosed herein, in accordance with some examples of the present disclosure. The computing device 800 can be used to implement various components of a core network (e.g., base station 120, AMF/MME 130, SMF/SGW-C/PGW-C 140, UPF/SGW-U/PGW-U 150, PCF/PCRF 160, etc.), a base station, and/or any servers, routers, gateways, gateway elements, administrative components, IMS network components (e.g., P-CSCF 172, S-CSCF 174, application server 180, etc.), etc. that can be used by a communication provider.

In various embodiments, the computing device 800 can include one or more processing units 802 and system memory 804. Depending on the exact configuration and type of computing device, the system memory 804 can be volatile (such as RAM), nonvolatile (such as ROM, flash memory, etc.) or some combination of the two. The system memory 804 can include an operating system 806, one or more program modules 808, program data 810, and location determination data 820 (e.g., UE location information, etc.). The system memory 804 may be secure storage or at least a portion of the system memory 804 can include secure storage. The secure storage can prevent unauthorized access to data stored in the secure storage. For example, data stored in the secure storage can be encrypted or accessed via a security key and/or password.

The computing device 800 can also include additional data storage devices (removable and/or non-removable) such as, for example, magnetic disks, optical disks, or tape. Such additional storage is illustrated in FIG. 8 by storage 812.

The computing device 800 may store, in either or both of the system memory 804 and the storage 912, location information, IP addresses, IP address data, block list information, permit list information, associated functions, timer information and/or timestamps, message transfer data, PDU session information, session management data, etc.

Non-transitory computer storage media of the computing device 800 can include volatile and nonvolatile, removable and non-removable media implemented in any method or technology for storage of information, such as computer-readable instructions, data structures, program modules, or other data. The system memory 804 and storage 812 are examples of computer-readable storage media. Non-transitory computer-readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 800. Any such non-transitory computer-readable storage media can be part of the computing device 800.

In various embodiments, any or all of the system memory 804 and storage 812 can store programming instructions which, when executed, implement some or all of the functionality described above as being implemented by one or more systems configured in the environment 100 and/or components of the core network 101 and/or the IMS network 170.

The computing device 800 can also have one or more input devices 814 such as a keyboard, a mouse, a touch-sensitive display, voice input device, etc. The computing device 800 can also have one or more output devices 816 such as a display, speakers, a printer, etc. can also be included. The computing device 800 can also contain one or more communication connections 818 that allow the device to communicate with other computing devices using wired and/or wireless communications.

### EXAMPLE CLAUSES

The following paragraphs describe various examples. Any of the examples in this section may be used with any other of the examples in this section and/or any of the other examples or embodiments described herein.

A: A method performed by a one or more computing devices configured at an Internet protocol (IP) multimedia system (IMS) network, the method comprising: receiving, at a call session control function (CSCF) configured at the IMS network from an application server, a hypertext transfer protocol (HTTP) GET request requesting location information for a user of a user equipment (UE); generating, at the CSCF, based at least in part on the HTTP GET request, a session initiation protocol (SIP) INFO request requesting the location information; transmitting, by the CSCF to the UE, the SIP INFO request; receiving, at the CSCF from the UE, a SIP PUBLISH message comprising the location information; generating, at the CSCF, based at least in part on the SIP PUBLISH message, an HTTP PUT message indicating the location information; and transmitting, by the CSCF to the application server, the HTTP PUT message.

B: The method of paragraph A, wherein receiving the HTTP GET request comprises detecting the HTTP GET request in an IMS data channel configured for communications between the UE and the application server.

C: The method of paragraph A or B 1, wherein receiving the SIP PUBLISH message comprises determining that the SIP PUBLISH message is associated with an IMS data channel configured for communications between the UE and the application server.

D: The method of any of paragraphs A-C, wherein the SIP PUBLISH message is generated by a UE dialer executing at the UE and in response to receiving the SIP INFO request.

E: The method of paragraph D, wherein the SIP PUBLISH message is generated by the UE dialer in response to receiving input via an interface presented at the UE indicating user approval of providing the location information to the application server.

F: The method of paragraph E, wherein the interface is generated at the UE by the UE dialer based at least in part on determining that the SIP INFO request is associated with non-emergency communications.

G: The method of any of paragraphs A-F, wherein generating the SIP INFO request is further based at least in part on an IMS data channel associated with the HTTP GET request.

H: A network computing device configured at an Internet protocol (IP) multimedia system (IMS) network, the network computing device comprising: one or more processors; one or more transceivers; and non-transitory computer-readable media storing computer-executable instructions that, when executed by the one or more processors, cause the one or more processors to perform operations comprising: receiving, at a call session control component from an application server, a first hypertext transfer protocol (HTTP) message requesting location information for a user of a user equipment (UE); generating, at the call session control component, based at least in part on the first HTTP message, a first session initiation protocol (SIP) message requesting the location information; transmitting the first SIP message from the call session control component to the UE; receiving a second SIP message at the call session control component from the UE, the second SIP message comprising the location information; generating, at the call session control component, based at least in part on the second SIP message, a second HTTP message comprising the location information; and transmitting the second HTTP message from the call session control component to the application server.

I: The network computing device of paragraph H, wherein generating the first SIP message is further based at least in part on an IMS data channel configured for communications between the UE and the application server.

J: The network computing device of paragraph I, wherein transmitting the second HTTP message comprises transmitting the second HTTP message in the IMS data channel.

K: The network computing device of any of paragraphs H-J, wherein generating the second HTTP message is further based at least in part on an IMS data channel associated with the first HTTP message.

L: The network computing device of any of paragraphs H-K, wherein the second SIP message is generated by a UE dialer executing at the UE and in response to receiving the first SIP message.

M: The network computing device of paragraph L, wherein the second SIP message is generated by the UE dialer in response to receiving input via an interface presented at the UE indicating user approval of providing the location information to the application server.

N: The network computing device of paragraph M, wherein the interface is generated at the UE by the UE dialer based at least in part on determining that the first SIP message is associated with non-emergency communications.

O: A non-transitory computer-readable media storing computer-executable instructions that, when executed by one or more processors, cause the one or more processors to perform operations comprising: receiving, at a call session control component configured at an Internet protocol (IP) multimedia system (IMS) network, from an application server, a first hypertext transfer protocol (HTTP) message requesting location information for a user of a user equipment (UE); generating, at the call session control component, based at least in part on the first HTTP message, a first session initiation protocol (SIP) message requesting the location information; transmitting the first SIP message from the call session control component to the UE; receiving a second SIP message at the call session control component from the UE, the second SIP message comprising the location information; generating, at the call session control component, based at least in part on the second SIP message, a second HTTP message comprising the location information; and transmitting the second HTTP message from the from the call session control component to the application server.

P: The non-transitory computer-readable media of paragraph O, wherein receiving the first HTTP message comprises detecting the first HTTP message in an IMS data channel configured for communications between the UE and the application server.

Q: The non-transitory computer-readable media of paragraph P, wherein transmitting the second HTTP message comprises transmitting the second HTTP message in the IMS data channel.

R: The non-transitory computer-readable media of paragraph Q, wherein generating the first SIP message is further based at least on part on the IMS data channel.

S: The non-transitory computer-readable media of paragraph Q, wherein the second SIP message is generated by a UE dialer executing at the UE and in response to receiving the first SIP message.

T: The non-transitory computer-readable media of paragraph S, wherein the second SIP message is generated by the UE dialer further in response to determining that the first SIP message is associated with non-emergency communications.

While the example clauses described above are described with respect to one particular implementation, it should be understood that, in the context of this document, the content of the example clauses can also be implemented via a method, device, system, computer-readable medium, and/or another implementation. Additionally, any of the examples A-T can be implemented alone or in combination with any other one or more of the examples A-T.

### CONCLUSION

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method performed by a one or more computing devices configured at an Internet protocol (IP) multimedia system (IMS) network, the method comprising:
receiving, at a call session control function (CSCF) configured at the IMS network from an application server, a hypertext transfer protocol (HTTP) GET request requesting location information for a user of a user equipment (UE);
generating, at the CSCF, based at least in part on the HTTP GET request, a session initiation protocol (SIP) INFO request requesting the location information;
transmitting, by the CSCF to the UE, the SIP INFO request;
receiving, at the CSCF from the UE, a SIP PUBLISH message comprising the location information;
generating, at the CSCF, based at least in part on the SIP PUBLISH message, an HTTP PUT message indicating the location information; and
transmitting, by the CSCF to the application server, the HTTP PUT message.

2. The method of claim 1, wherein receiving the HTTP GET request comprises detecting the HTTP GET request in an IMS data channel configured for communications between the UE and the application server.

3. The method of claim 1, wherein receiving the SIP PUBLISH message comprises determining that the SIP PUBLISH message is associated with an IMS data channel configured for communications between the UE and the application server.

4. The method of claim 1, wherein the SIP PUBLISH message is generated by a UE dialer executing at the UE and in response to receiving the SIP INFO request.

5. The method of claim 4, wherein the SIP PUBLISH message is generated by the UE dialer in response to receiving input via an interface presented at the UE indicating user approval of providing the location information to the application server.

6. The method of claim 5, wherein the interface is generated at the UE by the UE dialer based at least in part on determining that the SIP INFO request is associated with non-emergency communications.

7. The method of claim 1, wherein generating the SIP INFO request is further based at least in part on an IMS data channel associated with the HTTP GET request.

8. A network computing device configured at an Internet protocol (IP) multimedia system (IMS) network, the network computing device comprising:
one or more processors;
one or more transceivers; and
non-transitory computer-readable media storing computer-executable instructions that, when executed by the one or more processors, cause the one or more processors to perform operations comprising:
receiving, at a call session control component from an application server, a first hypertext transfer protocol (HTTP) message requesting location information for a user of a user equipment (UE);
generating, at the call session control component, based at least in part on the first HTTP message, a first session initiation protocol (SIP) message requesting the location information;
transmitting the first SIP message from the call session control component to the UE;
receiving a second SIP message at the call session control component from the UE, the second SIP message comprising the location information;
generating, at the call session control component, based at least in part on the second SIP message, a second HTTP message comprising the location information; and
transmitting the second HTTP message from the call session control component to the application server.

9. The network computing device of claim 8, wherein generating the first SIP message is further based at least in part on an IMS data channel configured for communications between the UE and the application server.

10. The network computing device of claim 9, wherein transmitting the second HTTP message comprises transmitting the second HTTP message in the IMS data channel.

11. The network computing device of claim 8, wherein generating the second HTTP message is further based at least in part on an IMS data channel associated with the first HTTP message.

12. The network computing device of claim 8, wherein the second SIP message is generated by a UE dialer executing at the UE and in response to receiving the first SIP message.

13. The network computing device of claim 12, wherein the second SIP message is generated by the UE dialer in response to receiving input via an interface presented at the UE indicating user approval of providing the location information to the application server.

14. The network computing device of claim 13, wherein the interface is generated at the UE by the UE dialer based at least in part on determining that the first SIP message is associated with non-emergency communications.

15. A non-transitory computer-readable media storing computer-executable instructions that, when executed by one or more processors, cause the one or more processors to perform operations comprising:
receiving, at a call session control component configured at an Internet protocol (IP) multimedia system (IMS) network, from an application server, a first hypertext transfer protocol (HTTP) message requesting location information for a user of a user equipment (UE);
generating, at the call session control component, based at least in part on the first HTTP message, a first session initiation protocol (SIP) message requesting the location information;
transmitting the first SIP message from the call session control component to the UE;
receiving a second SIP message at the call session control component from the UE, the second SIP message comprising the location information;
generating, at the call session control component, based at least in part on the second SIP message, a second HTTP message comprising the location information; and
transmitting the second HTTP message from the from the call session control component to the application server.

16. The non-transitory computer-readable media of claim 15, wherein receiving the first HTTP message comprises detecting the first HTTP message in an IMS data channel configured for communications between the UE and the application server.

17. The non-transitory computer-readable media of claim 16, wherein transmitting the second HTTP message comprises transmitting the second HTTP message in the IMS data channel.

18. The non-transitory computer-readable media of claim 17, wherein generating the first SIP message is further based at least on part on the IMS data channel.

19. The non-transitory computer-readable media of claim 17, wherein the second SIP message is generated by a UE dialer executing at the UE and in response to receiving the first SIP message.

20. The non-transitory computer-readable media of claim 19, wherein the second SIP message is generated by the UE dialer further in response to determining that the first SIP message is associated with non-emergency communications.
